(19) United States
(12) Patent Application Publication
(10) Pub. No.: US 2026/0238315 A1
(43) Pub. Date: Aug. 13, 2026

(54) SIGNALING FOR SIDELINK BEAM FAILURE RECOVERY

(71) Applicant: Apple Inc., Cupertino, CA (US)

(72) Inventors: Chunxuan Ye, San Diego, CA (US); Dawei Zhang, Saratoga, CA (US); Haitong Sun, Saratoga, CA (US); Hong He, San Jose, CA (US); Huaning Niu, San Jose, CA (US); Wei Zeng, Saratoga, CA (US)

(21) Appl. No.: 19/153,863

(22) PCT Filed: Feb. 9, 2024
(86) PCT No.: PCT/US2024/015130

§ 371 Date: Aug. 5, 2025

Related U.S. Application Data
(60) Provisional application No. 63/444,458, filed on Feb. 9, 2023.

(51) Int. Cl. H04B 7/06

(52) U.S. Cl. CPC H04B 7/06964; H04B 7/06962

(57) ABSTRACT

Systems and processes are for transmitting, from a first user equipment to a second user equipment, a beam failure recovery request (BFRQ) message to recover from a beam failure for a sidelink beam pair for unidirectional sidelink communication, the request identifying a new sidelink beam pair; receiving, at the first user equipment from the second user equipment, a response message confirming that the second user equipment is configured for communicating using the new sidelink beam pair that is identified in the BFRQ message; and activating, at the first user equipment based on the response message, a beam specified in the new sidelink beam pair.

### CLAIM OF PRIORITY

This application claims priority to U.S. Patent Application Ser. No. 63/444,458, filed on Feb. 9, 2023, the entire contents of which are hereby incorporated by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

A base station, such as a next generation node (gNB) can indicate a downlink reference signal such as a synchronization signal block (SSB) or channel state information reference signal (CSI-RS) to provide spatial receiver parameter indication for a user equipment (UE). The SSB or CSI-RS is provided based on a transmission configuration indicator (TCI) state. The gNB can configure a list of TCI states using radio resource control (RRC) signaling. The gNB can activate a number of TCI states using a medium access control (MAC) control element (CE). The UE tracks the number of TCI states. The UE performs receiver beam tracking and time and frequency offset tracking based on the downlink reference signals indicated in the number of TCI states. If the number of TCI states is greater than 1, the gNB can indicate a particular TCI state from the number TCI States by downlink control information (DCI).

### SUMMARY

This document describes methods and systems for sidelink (SL) transmissions in a wireless communications network. This document describes sidelink beam management, specifically sidelink beam failure recovery between a transmitting (Tx) user equipment (UE) and a receiving (Rx) UE for telecommunication networks such as Fifth Generation (5G) new radio (NR) networks any beyond. The sidelink beam pairing procedures are performed as a part of the beam management that includes the initial beam-pairing, beam maintenance, beam failure recovery, and so forth in a SL-CSI framework. The sidelink beam initial beam pairing procedures described herein can apply to frequency range 2 (FR2) transmissions in which UE-to-UE (sidelink) transmissions are unicast and on a directional beam.

The processes and systems described herein provide one or more of the following advantages. The Tx UE and the Rx UE are configured to trigger the sidelink beam recovery when there is a beam failure in sidelink scenarios. The described approaches to the sidelink beam failure recovery enables the Rx UE and the Tx UE to recover a beam pair for the directional sidelink link. The beam recovery procedures described herein are novel for sidelink scenarios. For Uu links (e.g., between a gNB and the UE), SSB-based beam recovery is used. In sidelink scenarios, there is no beam management scheme that is defined. The SSB-based beam recovery for Uu links is not applicable to sidelink scenarios. For Uu links, the SSB is only transmitted from the base stations. Each UE has beam pairing with the base station. Hence, the SSB only carries cell ID, not a transmitter (e.g., a UE) identifier. For sidelink scenarios, it is possible that every UE can send a S-SSB. Because there are multiple sidelink unicast pairs in the system, a number of S-SSB transmissions is large. The S-SSB does not carry UE identifier in the sidelink design. Thus, a Rx UE does not know whether the S-SSB is transmitted from a given Tx UE. The definitions described herein specify how beam pairing management is performed for sidelink communications.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example communication system that includes sidelink communications, according to some implementations.

FIGS. 2A-2B show example processes for beam failure recovery in a sidelink scenario.

FIG. 2C illustrates a network environment for execution of a sidelink beam failure management process.

FIGS. 3A-3B show example processes for beam failure recovery in a sidelink scenario.

FIG. 3C illustrates a network environment for execution of a sidelink beam failure management process.

FIG. 4 illustrates a network environment for execution of a sidelink beam failure management process.

FIGS. 5A-5C each illustrates a flowchart of an example method, according to some implementations.

FIG. 6 illustrates an example user equipment (UE), according to some implementations.

FIG. 7 illustrates an example access node, according to some implementations.

### DETAILED DESCRIPTION

The procedures described herein are for configuring a failure recovery a receiving (Rx) UE and a transmitting (Tx) UE in a telecommunications system. The beam failure recovery enables the UEs to recover a beam pair after beam failure between the UEs. Beam failure may occur in sidelink scenarios in which a signal from the Tx UE has a low quality or a low signal strength. In some examples, the Rx UE or Tx UE configured to send a sidelink beam failure recovery request (S-BFRQ) to a base station for assistance in beam recovery or directly to the Tx UE. The beam failure recovery can be done by the Rx UE and/or the Tx UE using an omnidirectional beam (rather than directional beam) based on different signaling configurations described in detail herein.

The signaling design of sidelink beam failure recovery is described herein. The signaling design includes signaling details of a sidelink beam failure recovery request (S-BFRQ) to Tx UE from Rx UE. The signaling details described herein specify a sidelink beam failure recovery response (S-BFRR) from the Tx UE to the Rx UE. The signaling details described herein specify a sidelink beam failure recovery request (S-BFRQ) report to the base station. The signaling details described herein specify a sidelink radio link failure (S-RLF) declaration configuration.

A timing for activation of a new beam pair in a sidelink beam failure recovery procedure is described. This process includes a specification for each of the Rx UE and the Tx UE regarding when to activate the new beams during the beam recovery process. For example, the processes described herein specify configurations of a transmission beam of an acknowledgement (ACK) for the S-BFRQ.

This specification describes sidelink SSB (S-SSB) modification to support beam measurement. This specification describes configurations for resources for S-SSB for beam measurement. This can replace the channel state information reference signal (CSI-RS) based beam measurement for sidelink scenarios. In Uu scenarios, the SSB can be used for beam measurement. In sidelink scenarios, the SSB includes the sidelink cell identifier (SSID). Conventionally, the SSB does not a UE identifier. Because any UE can send SSB data, a transmitter identifier is not included in the SSB. For beam measurement applications in SSB data, a transmitting UE identifier is added into the SSB to replace or supplement CSI-RS signaling. For example, in some implementations, there can be a SSB slot for sidelink beam measurement. This specification describes resources used for SSBs for SSB-based beam measurement and the configuration of the transmitted S-SSBs that are used for beam failure recovery.

A procedure for beam correspondence is described herein. For example, a first UE may use a Tx beam to send data, and this UE may use a corresponding paired Rx beam to receive data. The Tx beam and the Rx beam are corresponding beams. The beam pair can be simplified after being established. This can be responsive to UE capabilities and prior negotiation between the Rx UE and the Tx UE.

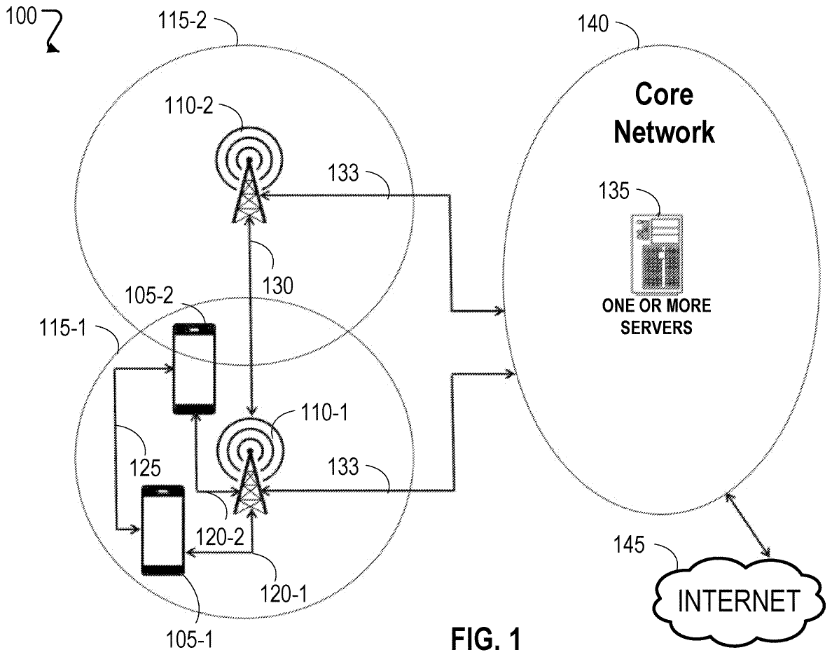

FIG. 1 illustrates an example communication system 100 that includes sidelink communications, according to some implementations. It is noted that the system of FIG. 1 is merely one example of a possible system, and that features of this disclosure may be implemented in other wireless communication systems.

The following description is provided for an example communication system that operates in conjunction with fifth generation (5G) networks as provided by 3GPP technical specifications. However, the example implementations are not limited in this regard and the described examples may apply to other networks that may benefit from the principles described herein, such as 3GPP Long Term Evolution (LTE) networks, Wi-Fi or Worldwide Interoperability for Microwave Access (WiMaX) networks, and the like. Furthermore, other types of communication standards are possible, including future 3GPP systems (e.g., Sixth Generation (6G)), IEEE 802.16 protocols, or the like. While aspects may be described herein using terminology commonly associated with 5G NR, aspects of the present disclosure can be applied to other systems, such as 3G, 4G, and/or systems subsequent to 5G (e.g., 6G).

Frequency bands for 5G NR may be separated into two different frequency ranges. Frequency Range 1 (FR1) may include frequency bands operating in sub-6 GHz frequencies, some of which are bands that may be used by previous standards and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1.

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, an LTE-based access to unlicensed spectrum (LTE-U), a 5G protocol, a NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs (also called PC5-RRC signaling). The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

In some implementations, the UEs 105 may be configured with parameters for communicating via the Uu interface and/or the sidelink interface. In some examples, the UEs 105 may be “pre-configured” with some parameters. In these examples, the parameters may be hardwired into the UEs 105 or coded into spec. Additionally and/or alternatively, the UEs 105 may receive the parameters from the one or more of the base stations 110.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

In some implementations, one or more sidelink radio bearers may be established on the sidelink 125. The sidelink radio bearers can include signaling radio bearers (SL-SRB) and/or data radio bearers (SL-DRB).

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short-to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may refer generally to devices that are associated with mobile actors or traffic participants in the V2X system, e.g., mobile (able-to-move) communication devices such as vehicles, pedestrian user equipment (PUE) devices, and roadside units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the UEs 105 are configured to use a resource pool for sidelink communications. A sidelink resource pool defines the time-frequency resources used for sidelink communications, and may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, an exceptional resource pool may be configured for the UEs 105, perhaps by the base stations 110. The exceptional resource pool includes resources that the UEs 105 can use in exceptional cases, such as Radio Link Failure (RLF). The exceptional resource pool may include resources selected based on a random allocation of resources.

In some implementations, a UE that is initiating a communication with another UE is referred to as a transmitter UE (TX UE), and the UE receiving the communication is referred to as a receiver UE (RX UE). For example, UE 105-1 may be a TX UE and UE 105-2 may be an RX UE. Although FIG. 1 illustrates a single TX UE communicating with a single RX UE, a TX UE may communicate with more than one RX UE via sidelink.

In some implementations, a TX UE that is initiating sidelink communication may determine the available resources (e.g., sidelink resources) and may select a subset of these resources to communicate with an RX UE based on a resource allocation scheme. Example resource allocation schemes include Mode 1 and Mode 2 resource allocation schemes. In Mode 1 resource allocation scheme (referred to as “Mode 1”), the resources are allocated by a network node for in-coverage UEs. In Mode 2 resource allocation scheme (referred to as “Mode 2”), the TX UE selects the sidelink resources (e.g., sidelink transmission resources).

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

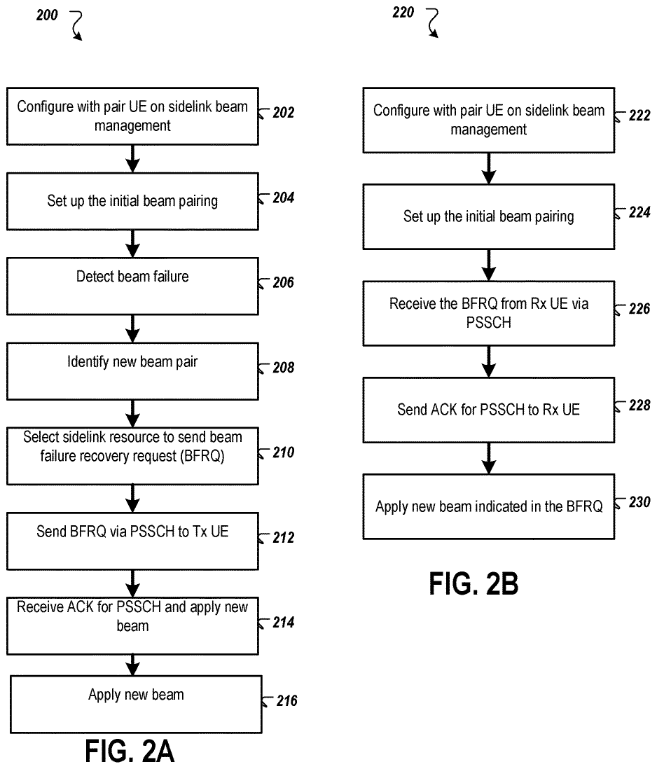

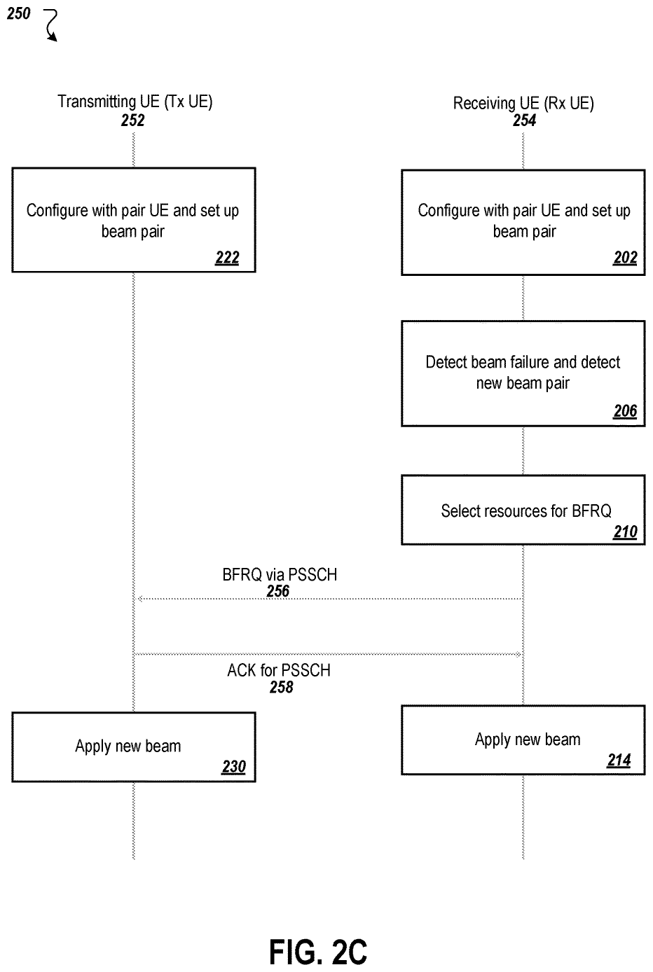

FIGS. 2A-2B show example processes 200, 220, respectively, for beam failure recovery in a sidelink scenario. Processes 200, 220 can be performed by UEs, such as UEs 105 of FIG. 1. Specifically, process 200 for beam failure recovery can be performed by a Rx UE. Specifically, process 220 for beam failure recovery can be performed by a Tx UE. The processes are first described generally, and then the specific details for the signal configurations are described subsequently. Processes 200, 220 of FIGS. 2A-2B include use of the BFRQ and the subsequent acknowledgement or response being sent between the Rx UE and the Tx UE using the physical sidelink shared channel (PSSCH). As subsequently described, FIG. 2C shows a network environment 250 illustrating the signaling between the Tx UE and the Rx UE.

Process 200 of FIG. 2A includes the following operations. A UE, such as a Rx UE, configures (202) a communication link with a Tx UE on a sidelink beam management. The communication link can include an omnidirectional beam. The Rx UE is configured to set up (204) an initial beam pairing. The initial beam pairing includes sending a beam pairing request, receiving an acknowledgement, measuring different beams metrics (e.g. a reference signal received power RSRP value), selecting a beam based on the measured beam metrics, confirming the selected beam and activating the beam. Once the beam pair is established and a beam failure occurs, the Rx UE is configured to detect (206) the beam failure. The beam failure can be detected by determining that the beam communication has been lost or has dropped below a threshold RSRP.

The Rx UE is configured to initiate beam failure recovery responsive to detecting beam failure. The Rx UE is configured to identify (208) a new beam pair for use with the Tx UE. The new beam pair can be identified based on RSRP measurements associated with received beams that were previously received. The Rx UE selects (210) a sidelink resource for sending a beam failure recovery request (BFRQ) to the Tx UE. The BFRQ specifies the new beam pair to the Tx UE. The particular sidelink resources that are selected are described subsequently in greater detail. For example, the Rx UE can transmit (212) the BFRQ using the PSSCH. The Rx UE is configured to receive (214), from the Tx UE, a response, such as an acknowledgment response. If an ACK response is received (in a successful beam failure recovery), the Rx UE activates (216) the newly selected beam for the beam pair with the Tx UE. Beam activation by the Rx UE can be based on predefined or dynamic timing, as subsequently described.

Process 220 of FIG. 2B includes the following operations. A UE, such as a Tx UE, configures (222) a communication link with a Rx UE on a sidelink beam management. The communication link can include an omnidirectional beam. The Tx UE is configured to set up (224) an initial beam pairing. The initial beam pairing includes sending a beam pairing request, receiving an acknowledgement, measuring different beams metrics (e.g. a reference signal received power RSRP value), selecting a beam based on the measured beam metrics, confirming the selected beam and activating the beam. Once the beam pair is established and a beam failure occurs, the Tx UE is configured to receive (226) a BFRQ from the Rx UE when a beam failure occurs. The Tx UE relies on the Rx UE to detect beam failure and send the BFRQ for beam failure recovery. The beam failure can be detected by the Rx UE by determining that the beam communication has been lost or has dropped below a threshold RSRP.

The Tx UE is configured to respond to the BFRQ. The Tx UE is configured to send (228), from the Tx UE, a response to the BFRQ received from the Rx UE. Generally, the BFRQ can be received over PSSCH. The Tx UE, responsive to receiving the BFRQ specifying the new beam pair, sends the acknowledgment response if the Tx UE is capable for using the specified new beam pair. If so, the Tx UE sends the ACK reply. The Tx UE then activates (230) the new beam. Beam activation by the Tx UE can be based on predefined or dynamic timing, as subsequently described.

FIG. 2C shows a network environment 250 of an example Tx UE 252 and an example Rx UE 254 that are performing the respective processes 220, 200 as previously described. In some implementations, the Tx UE 252 and the Rx UE 254 can be the UEs 105 of FIG. 1. As shown in FIG. 2C, the Rx UE sends the BFRQ via PSSCH in a message 256. The Tx UE replies with an ACK for PSSCH message 258. Messages 256 and 258 are described in further detail, subsequently.

The signaling design of sidelink beam failure recovery is now described, specifically the signaling details of sidelink beam failure recovery request (S-BFRQ). The S-BFRQ can be sent in a PSSCH transmission. In a first example, a medium access control (MAC) control element (CE) is used as a container for sending the S-BFRQ. In this example, the MAC CE can include a same format as the MAC CE used for sidelink beam switching or sidelink beam indication. Specifically, the MAC CE can include a sidelink new beam identifier and a set of reserved bits. In another example, the sidelink S-BRFQ is included in sidelink control information (SCI) stage 2 messaging. The format of the request can a 2-D format that is described further in release 18. Specifically, 3GPP TS 38.212 Section 8.4.1 and Section 8.3.1.1, V16.2.0 (2020-07) describes SCI formats for SCI stage 1 and SCI stage 2. 3GPP TS 38.212 version 16.2.0 Release 16 is incorporated herein by reference in entirety.

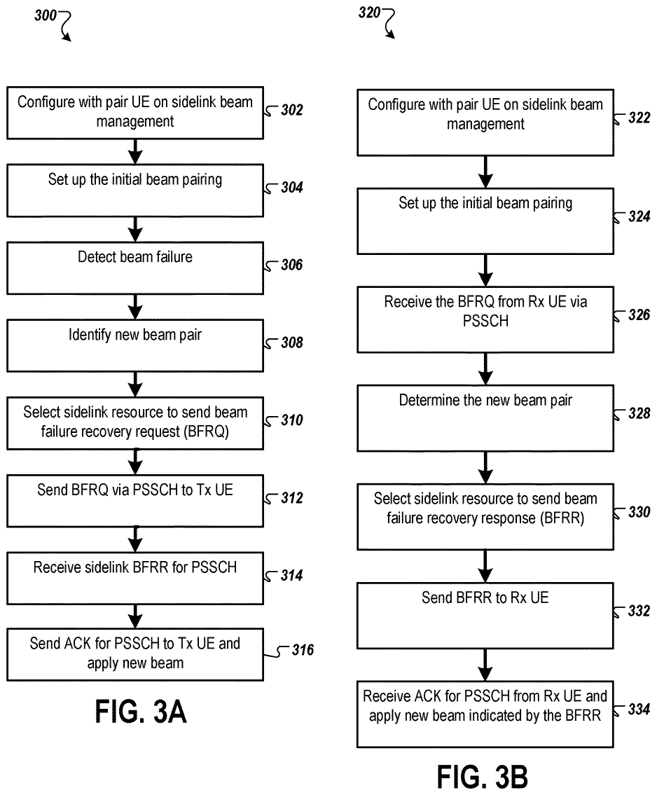

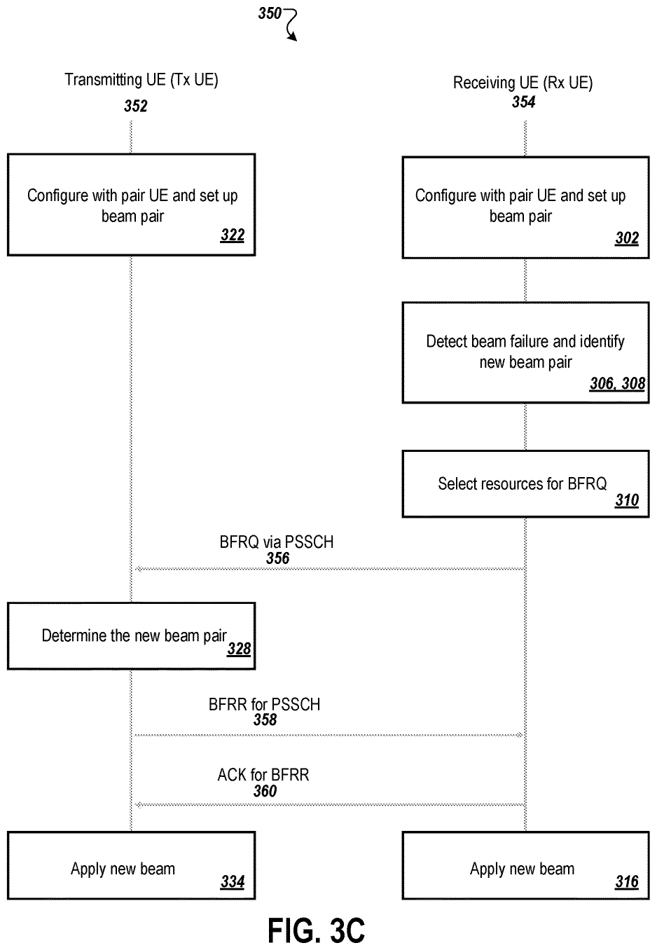

The signaling design for the sidelink beam failure recovery is described in relation to a second scenario illustrated in FIGS. 3A-3C. FIGS. 3A-3B show example processes 300, 320, respectively, for beam failure recovery in a sidelink scenario. Processes 300, 320 can be performed by UEs, such as UEs 105 of FIG. 1. Specifically, process 300 for beam failure recovery can be performed by a Rx UE. Specifically, process 320 for beam failure recovery can be performed by a Tx UE. The processes are first described generally, and then the specific details for the signal configurations are described subsequently. Processes 300, 320 of FIGS. 3A-3B include use of the BFRQ and the subsequent acknowledgement (ACK) and S-BFRR being sent between the Rx UE and the Tx UE using the physical sidelink shared channel (PSSCH). As subsequently described, FIG. 3C shows a network environment 350 illustrating the signaling between the Tx UE and the Rx UE for processes 300, 320.

Process 300 of FIG. 3A includes the following operations. A UE, such as a Rx UE, configures (302) a communication link with a Tx UE on a sidelink beam management. The communication link can include an omnidirectional beam. The Rx UE is configured to set up (304) an initial beam pairing. The initial beam pairing includes sending a beam pairing request, receiving an acknowledgement, measuring different beams metrics (e.g. a reference signal received power RSRP value), selecting a beam based on the measured beam metrics, confirming the selected beam and activating the beam. Once the beam pair is established and a beam failure occurs, the Rx UE is configured to detect (306) the beam failure. The beam failure can be detected by determining that the beam communication has been lost or has dropped below a threshold RSRP.

The Rx UE is configured to initiate beam failure recovery responsive to detecting beam failure. The Rx UE is configured to identify (308) a new beam pair for use with the Tx UE. The new beam pair can be identified based on RSRP measurements associated with received beams that were previously received. The Rx UE selects (310) a sidelink resource for sending a beam failure recovery request (BFRQ) to the Tx UE. The BFRQ identifies a candidate new beam pair to the Tx UE, which can determine the beam pair for use and reply with the BFRR, subsequently described. The particular sidelink resources that are selected are described subsequently in greater detail. For example, the Rx UE can transmit (312) the BFRQ using the PSSCH. The Rx UE is configured to receive (314), from the Tx UE, a response, such as a BFRR. If a BFRR is received (in a successful beam failure recovery process), the Rx UE activates (316) the newly selected beam for the beam pair with the Tx UE. Beam activation by the Rx UE can be based on predefined or dynamic timing, as subsequently described.

Process 320 of FIG. 3B includes the following operations. A UE, such as a Tx UE, configures (322) a communication link with a Rx UE on a sidelink beam management. The communication link can include an omnidirectional beam. The Tx UE is configured to set up (324) an initial beam pairing. The initial beam pairing includes sending a beam pairing request, receiving an acknowledgement, measuring different beams metrics (e.g. a reference signal received power RSRP value), selecting a beam based on the measured beam metrics, confirming the selected beam and activating the beam. Once the beam pair is established and a beam failure occurs, the Tx UE is configured to receive (326) a BFRQ from the Rx UE when a beam failure occurs. The Tx UE relies on the Rx UE to detect beam failure and send the BFRQ for beam failure recovery. The beam failure can be detected by the Rx UE by determining that the beam communication has been lost or has dropped below a threshold RSRP.

The Tx UE is configured to respond to the BFRQ. The Tx UE is configured to determine (328) a new beam pair for communicating with the Rx UE. In this example, in contrast to the processes 200, 320, the Tx UE determines the beam pair and sends (328), from the Tx UE, a response BFRR back to the Rx UE. The BFRR identifies the beam pair determined or selected by the Tx UE. The Tx UE can select (330) a sidelink resource for sending the beam recovery response BFRR back to the Rx UE. Generally, the BFRQ and BFRR can be transmitted over PSSCH. The Tx UE, responsive to receiving the BFRQ specifying the new beam pair, transmits (332) the BFRR back to the Rx UE using the selected resources (e.g., PSSCH). The Tx UE then waits to receive (334) an acknowledgement response from the Rx UE. The acknowledgment response confirms that the Rx UE is configured for using the specified new beam pair. If so, the Rx UE sends the ACK reply. The Tx UE then activates (334) the new beam. Beam activation by the Tx UE can be based on predefined or dynamic timing, as subsequently described.

FIG. 3C shows a network environment 350 of an example Tx UE 352 and an example Rx UE 354 that are performing the respective processes 320, 300 as previously described. In some implementations, the Tx UE 352 and the Rx UE 354 can be the UEs 105 of FIG. 1. As shown in FIG. 3C, the Rx UE sends the BFRQ via PSSCH in a message 356. The Tx UE replies with the BFRR for PSSCH in message 358, which corresponds to action 332 previously described. The Rx sends an ACK for PSSCH message 360, which corresponds to action 316. Messages 356, 358, and 360 are described in further detail, subsequently.

The signaling design of sidelink beam failure recovery is now described, specifically the signaling details of sidelink beam failure recovery response (S-BFRR). The S-BFRR can be sent in a PSSCH transmission. In a first example, a medium access control (MAC) control element (CE) is used as a container for sending the S-BFRR. In this example, the MAC CE can include a same format as the MAC CE used for sidelink beam switching and indication. Specifically, the MAC CE can include a sidelink new beam identifier and a set of reserved bits. In another example, the sidelink S-BRFR is included in sidelink control information (SCI) stage 2 messaging. The format of the request can a 2-D forma.

The signaling design of sidelink beam failure recovery for the activation of new beam pair in sidelink beam failure recovery is now described. The timing is aligned for the Rx UE and the Tx UE. In an example, the sidelink BFRQ message 256 includes the identifier of the new beam that is selected. In this case, the new beam pair is activated immediately after the ACK message 258 of the sidelink BFRQ is received at the Rx (e.g., see processes 200, 220 previously described in relation to FIGS. 2A-2C). In another example, the sidelink BFRQ message 356 includes only an indication of beam failure detection (see e.g., processes 300, 320, previously described in relation to FIGS. 3A-3C). A new beam is indicated in BFRR message 358 from the Tx UE. The new beam pair is activated immediately after the ACK message 360 of the sidelink BFRR is received at the Tx UE from the Rx UE.

A transmission beam confirmation for the ACK message for sidelink BFRQ is now described. In an example, the ACK message 258 for sidelink BFRQ is based on the new beam as indicated in sidelink BFRQ message 256, as previously described in relation to FIG. 2C and processes 200, 220. The Tx UE uses the beam indicated in sidelink BFRQ message 256 for transmitting the ACK message 258 for sidelink BFRQ. In this example, the Rx UE uses the Rx beam corresponding to the beam indicated in the sidelink BFRQ message 256 for receiving the ACK message 258 for sidelink BFRQ. In another example, the ACK message 258 for sidelink BFRQ is based on an omnidirectional beam. In another example, the ACK message 258 for sidelink BFRQ is based on a (configured) fallback beam. In another example, the ACK message for sidelink BFRQ is based on the old serving beam.

The beam management process can include sidelink SSB (S-SSB) based beam measurement. The S-SSB based beam measurement can be used independent from the beam failure recovery processes 200, 220 and 300, 320 described herein or in combination with these processes. In this example, S-SSBs are used not only for synchronization but also for beam measurement. The resources for S-SSB for beam measurement can include the following. In an example, the resources for S-SSB for measurement include reusing legacy (Release 16, Release 17) S-SSB slots. In another example, additional candidate S-SSB slots are used for beam measurement. This is separate from the other data of the S-SSB. Some slots of the S-SSB are configured for synchronization, and other, separate slots are configured for beam measurement. In this example, additional candidate S-SSB slots can be introduced for the purpose of beam measurement. In a first example, candidate S-SSB slots can be (pre) configured independently from the legacy S-SSB configuration. In a first case, the number of candidate S-SSB slots in an S-SSB periodicity is (pre) configured. The location(s) of the candidate S-SSB slots are determined based on the number of candidate S-SSB slots. In a second case, both the number and location of candidate S-SSB slots are (pre) configured. Because the S-SSBs have a 160 ms periodicity and 6 candidate slots, locations of the candidate slots in the time domain can be determined. In a second example, candidate S-SSB slots are configured depending on a legacy S-SSB configuration. Each legacy S-SSB slot has the subsequent (pre) configured N candidate S-SSB slots. In a third example, candidate S-SSB slots are part of a resource pool. If the candidate slots are part of the resource pool, a sub-channel for the S-SSB transmission is used. In another example, the candidate S-SSB slots are not part of the resource pool.

The sidelink SSB based beam measurement can include the following contents. In an example, the physical sidelink broadcast channel (PSBCH) includes a field of a UE identifier (UE ID). It is possible to shorten the length of the UE ID to fit a capacity of the PSBCH. In another example, a PSBCH scrambling sequence is generated based on the UE ID. The PSBCH scrambling sequence can be initialized with Cᵢₙᵢₜ, defined in Equation (1) as:

$${C}_{init} = {N}_{ID}^{SL} + {UE}_{ID} \qquad ( 1 )$$

wherein the UE_{ID} is 10 least significant bits (LSB) or most significant bits (MSB) of the Tx UE sidelink source identifier. The N^{SL}_{ID} is the legacy sidelink cell identifier. The operation is in XOR, or with modulo 2.

In another example, the PSBCH demodulation reference signal (DMRS) scrambling sequence is generated by using UE ID. The PSBCH DMRS scrambling sequence is initialized with Cᵢₙᵢₜ, defined in Equation (1).

The sidelink beam correspondence is now described. Beam correspondence indicates that a beam selected for downlink reception can also be used for uplink transmission. Beam correspondence may depend on UE capability. A UE may exchange its capability of sidelink beam correspondence in PC5-RRC signaling. In some implementations, if both UEs (Tx UE and Rx UE) support sidelink beam correspondence, then the Tx beam is always equal to Rx beam of each UE. In some implementations, if one of the UEs (Tx UE or Rx UE) does not support sidelink beam correspondence, then the sidelink beam pairing or sidelink beam management is one-way.

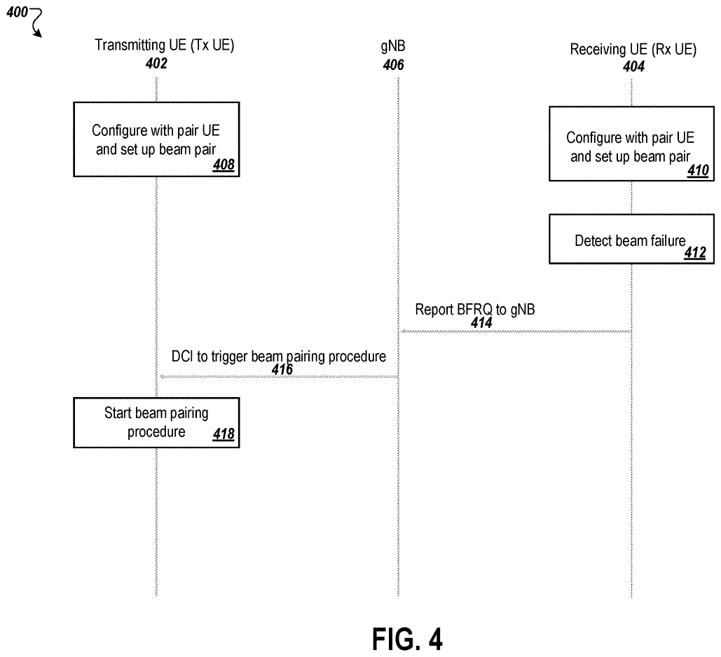

FIG. 4 illustrates a network environment 400 for execution of a sidelink beam failure management process. Environment 400 includes a Tx UE 402, an Rx UE 404, and a gNB 406, which are similar to the Tx UE, Rx UE, and gNB described previously. For example, the UEs 402, 404 can include UEs 105 of FIG. 1. The gNB can include the base station 110 of FIG. 1. In this example process, the Tx UE 402 configures (408) a beam pair with UE 404, as previously described in relation to FIGS. 2A-3C. Similarly, Rx UE 404 configures (410) a beam pair with the Tx UE 404 as previously described in relation to FIGS. 2A-3C. The Rx UE detects (412) a beam failure, as previously described in relation to FIGS. 2A-3C. The Rx UE sends a message 414 that includes the BFRQ report, subsequently described. The report message 414 is sent to the gNB. The gNB processes the report and generates a downlink control information (DCI) message 416 for sending to the Tx UE 402. The DCI message 416 is configured to trigger a beam pairing procedure previously described. The Tx UE 402 then initiates (418) performance of the beam pairing procedure. The beam pairing includes sending a beam pairing request, receiving an acknowledgement, measuring different beams metrics (e.g. a reference signal received power RSRP value), selecting a beam based on the measured beam metrics, confirming the selected beam and activating the beam.

The signaling design of sidelink beam failure recovery is now described, specifically the signaling details of the S-BFRQ report to the base station (e.g., a gNB 406). The base station 406 can include the base station 110 of FIG. 1. The content of the report message 414 includes an identifier of the Tx UE. This message indicates to the base station that it should pass the message to a particular UE identified as the Tx UE in the report. The content of the report message 414 indicates a resource pool index. The index specifies the particular aggregate collection of resources for performing the sidelink communications on the new beam. The content of the report message 414 includes an indication of a candidate beam (e.g., the selected new beam), selected by the Rx UE.

The signaling design of sidelink beam failure recovery is now described, specifically the signaling details of the sidelink radio link failure (S-RLF) declaration. A timer is (pre) configured per resource pool or configured per PC5-RRC. The timer ensure that the channel (e.g., PSSCH) used to communicate the S-BFRQ represents a connection. For example, if the BFRQ is not received at the Tx UE, no response (e.g., the S-BFRR message) or ACK is sent by the Tx UE to the Rx UE, as previously described. If there is no connection on the channel, the Rx UE may declare sidelink radio link failure because of no connection. In an example, the timer is started at a (pre) configured time. In a first example, the timer is started when the sidelink beam failure is detected. In another example, the timer is started when the S-BFRQ is initially transmitted. The timer is stopped at a (pre) configured time. For example, the timer is stopped when the sidelink beam failure recovery response (S-BFRR) is received at the Rx UE. In another example, the timer is stopped when an acknowledgement ACK for the S-BFRQ is received from the Tx UE. If neither the ACK nor the S-BFRR is received and the timer expires, the Rx UE declares a S-RLF state.

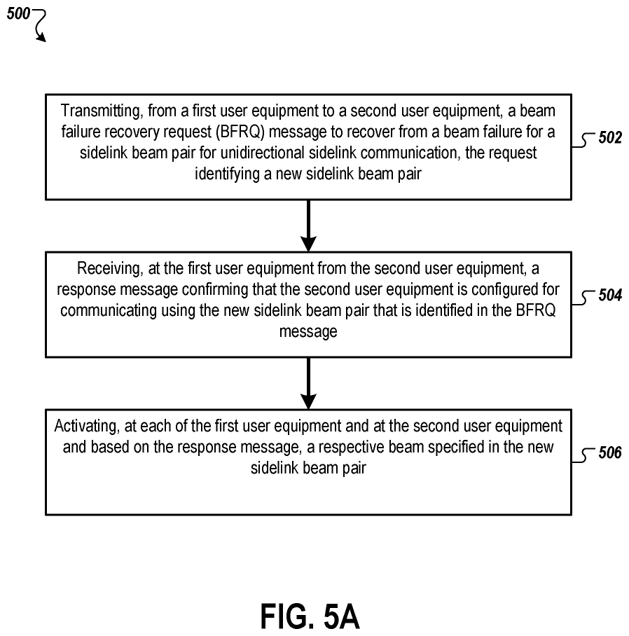

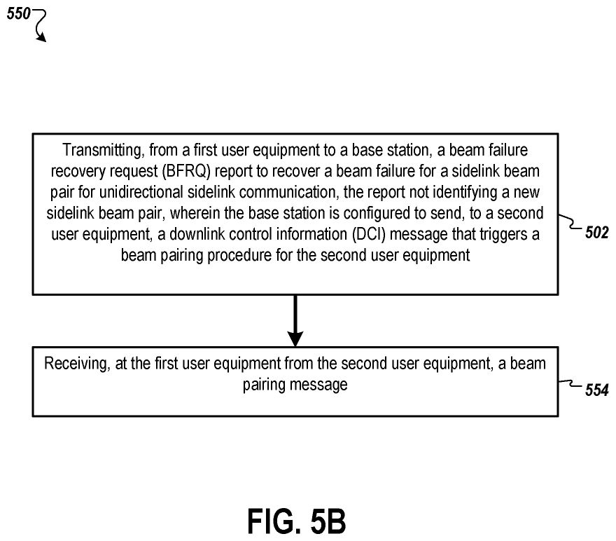

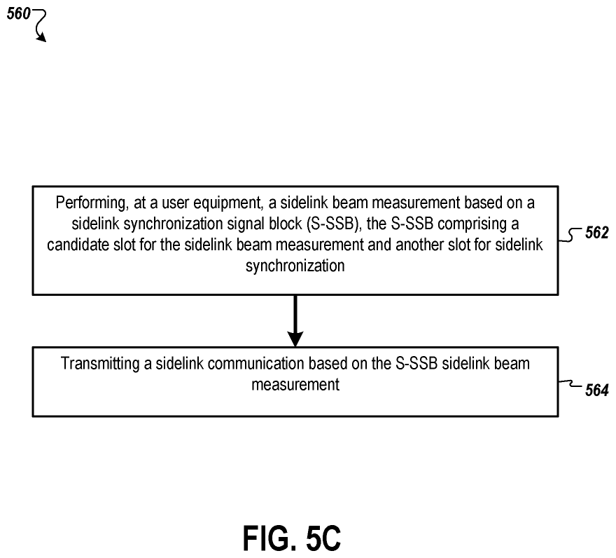

FIG. 5A illustrates a flowchart of an example method 500, according to some implementations. For clarity of presentation, the description that follows generally describes method 500 in the context of the other figures in this description. For example, method 500 can be performed by UE 105 of FIG. 1. It will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order.

Method 500 includes transmitting (502), from a first user equipment to a second user equipment, a beam failure recovery request (BFRQ) message to recover from a beam failure for a sidelink beam pair for unidirectional sidelink communication. The request identifies a new sidelink beam pair. In some implementations, the request selects a new sidelink pair. The process 500 includes receiving (504), at the first user equipment from the second user equipment, a response message confirming that the second user equipment is configured for communicating using the new sidelink beam pair that is identified in the BFRQ message. The process 500 includes activating (506), at each of the first user equipment and at the second user equipment and based on the response message, a respective beam specified in the new sidelink beam pair.

In some implementations, the response message comprises an acknowledgment (ACK) message. In some implementations, the request message and the response message are transmitted on a physical sidelink shared channel (PSSCH).

In some implementations, the response message comprises a beam failure recovery response (BFRR) message that specifies a particular new beam pair. The process 500 includes, in response to receiving the BFRR message at the first user equipment, transmitting, from the first user equipment to the second user equipment, an acknowledgement message. The process 500 includes applying a particular new beam included in the particular new beam pair. In some implementations, the particular new beam pair is the same as the identified new beam pair.

In some implementations, the BFRQ message is sent in a medium access control (MAC) control element (CE) that specifies a new beam identifier. In some implementations, the MAC CE has a same format as a beam switching or beam indication MAC CE.

In some implementations, the BFRQ message is sent in a sidelink control information (SCI) stage 2 message that includes a new beam identifier.

In some implementations, the response message comprises a BFRR message, and wherein the BFRR message is sent in a MAC CE that specifies a new beam identifier. In some implementations, the MAC CE has a same format as a beam switching or beam indication MAC CE.

In some implementations, the response message comprises a BFRR message, and wherein the BFRR message is sent in a sidelink control information (SCI) stage 2 message that includes a new beam identifier.

In some implementations, the process 500 includes initiating a timer at the first user equipment. In some implementations, the process 500 includes, in response to the timer expiring, declaring a sidelink radio link failure (S-RLF). In some implementations, the timer initiates when the first user equipment detects sidelink beam failure. In some implementations, the timer initiates when the first user equipment transmits the BFRQ message. In some implementations, the timer stops when the first user equipment receives the response message from the second user equipment. In some implementations, the timer stops when the first user equipment receives the response message from the second user equipment, the response comprising a BFRR message. In some implementations, the timer stops when the first user equipment receives the response message from the second user equipment, the response comprising an acknowledgement (ACK) for the BFRQ message.

In some implementations, the BFRQ message specifies a new beam identifier, and wherein the new beam pair is activated immediately after the response message from the second user equipment is received at the first user equipment.

In some implementations, the BFRQ message does not specify a new beam identifier, and wherein the response message includes a BFRR message, from the second user equipment, that specifies the new beam identifier, and wherein the new beam pair is activated immediately after an acknowledgment of the BFRR message sent by the first user equipment is received at the second user equipment.

In some implementations, the response message includes an ACK message, and wherein the ACK message is transmitted by the second user equipment using a new beam specified in the BFRQ message.

In some implementations, the response message includes an ACK message, and wherein the ACK message is received by the first user equipment using a new beam specified in the BFRQ message.

In some implementations, the response message includes an ACK message, and wherein the ACK message based on an omnidirectional beam.

In some implementations, the response message includes an ACK message, and wherein the ACK message based on a configured fallback beam.

In some implementations, the response message includes an ACK message, and wherein the ACK message based on a serving beam.

In some implementations, the first user equipment is configured to measure beams of the sidelink beam pair using a sidelink synchronization signal block (S-SSB) slot. In some implementations, the S-SSB slot is based on a number of (pre) configured candidate slots, wherein a location for each of the candidate slots is based on the number. In some implementations, the S-SSB slot is based on a number of preconfigured candidate slots, wherein a location for each of the candidate slots is (pre) configured. In some implementations, the S-SSB slot is specified in a resource pool, and wherein a sub-channel is used for transmission of the S-SSB. In some implementations, the S-SSB includes a field for an identifier of the second user equipment. In some implementations, the identifier of the second user equipment is shortened to fit a capacity of a physical sidelink broadcast channel (PSBCH). In some implementations, a physical sidelink broadcast channel (PSBCH) scrambling sequence is generated based on an identifier of the second user equipment. In some implementations, a demodulation reference signal (DMRS) scrambling sequence is generated based on an identifier of the second user equipment.

In some implementations, the first user equipment is configured to exchange a capability of sidelink beam correspondence in PC5-RRC signaling.

FIG. 5B illustrates a flowchart of an example method 550, according to some implementations. For clarity of presentation, the description that follows generally describes method 550 in the context of the other figures in this description. For example, method 550 can be performed by UE 105 of FIG. 1. It will be understood that method 550 can be performed, for example, by any suitable system, environment, software, hardware, or a combination of systems, environments, software, and hardware, as appropriate. In some implementations, various steps of method 550 can be run in parallel, in combination, in loops, or in any order.

The method 550 includes transmitting (552), from a first user equipment to a base station, a beam failure recovery request (BFRQ) report to recover a beam failure for a sidelink beam pair for unidirectional sidelink communication, the report not identifying a new sidelink beam pair, wherein the base station is configured to send, to a second user equipment, a downlink control information (DCI) message that triggers a beam pairing procedure for the second user equipment. The method 550 includes receiving (554), at the first user equipment from the second user equipment, a beam pairing message.

In some implementations, the report specifies an identifier that identifies the second user equipment to the base station. In some implementations, the report specifies a resource pool index. In some implementations, the report specifies a candidate beam.

FIG. 5C illustrates a flowchart of an example method 560, according to some implementations. For clarity of presentation, the description that follows generally describes method 560 in the context of the other figures in this description. For example, method 560 can be performed by UE 105 of FIG. 1. It will be understood that method 560 can be performed, for example, by any suitable system, environment, software, hardware, or a combination of systems, environments, software, and hardware, as appropriate. In some implementations, various steps of method 560 can be run in parallel, in combination, in loops, or in any order.

The method 560 includes performing (562), at a user equipment, a sidelink beam measurement based on a sidelink synchronization signal block (S-SSB), the S-SSB comprising a candidate slot for the sidelink beam measurement and another slot for sidelink synchronization. The method 560 includes transmitting (564) a sidelink communication based on the S-SSB sidelink beam measurement.

In some implementations, the S-SSB slot is based on a number of (pre) configured candidate slots, wherein a location for each of the candidate slots is based on the number.

In some implementations, the S-SSB slot is based on a number of preconfigured candidate slots, wherein a location for each of the candidate slots is (pre) configured.

In some implementations, the S-SSB slot is specified in a resource pool, and wherein a sub-channel is used for transmission of the S-SSB.

In some implementations, the S-SSB includes a field for an identifier of a second user equipment. In some implementations, the identifier of a second user equipment is shortened to fit a capacity of a physical sidelink broadcast channel (PSBCH).

In some implementations, a physical sidelink broadcast channel (PSBCH) scrambling sequence is generated based on an identifier of a second user equipment.

In some implementations, a demodulation reference signal (DMRS) scrambling sequence is generated based on an identifier of a second user equipment.

The example methods 500, 550, 560 shown in FIGS. 5A-5C can be modified or reconfigured to include additional, fewer, or different steps (not shown in FIGS. 55A-5C, which can be performed in the order shown or in a different order.

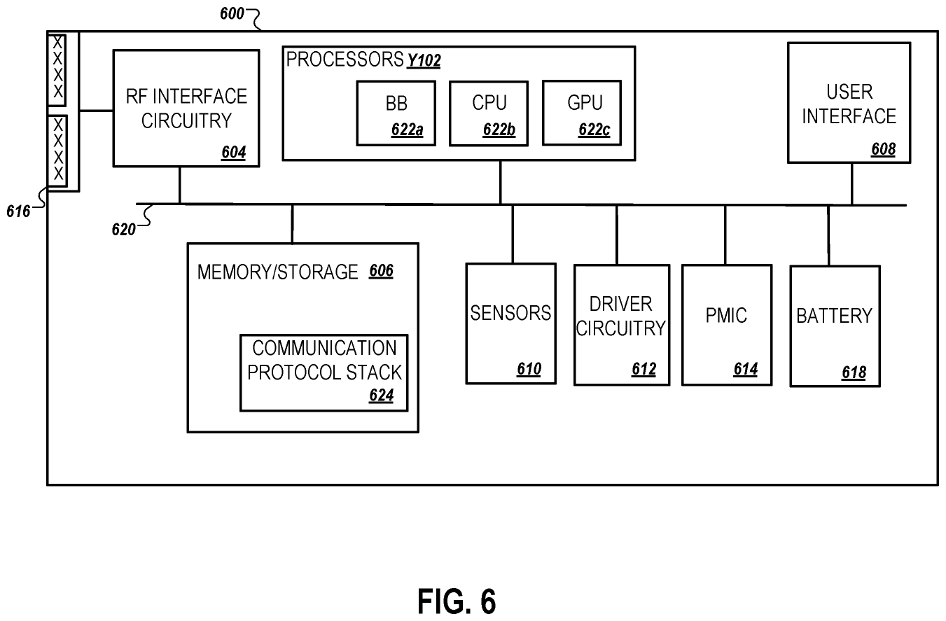

FIG. 6 illustrates an example UE 600, according to some implementations. The UE 600 may be similar to and substantially interchangeable with UEs 105 of FIG. 1.

The UE 600 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 600 may include processors 602, RF interface circuitry 604, memory/storage 606, user interface 608, sensors 610, driver circuitry 612, power management integrated circuit (PMIC) 614, one or more antenna(s) 616, and battery 618. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc. that allows various circuit components (on common or different chips or chipsets) to interact with one another.

The processors 602 may include processor circuitry such as, for example, baseband processor circuitry (BB) 622A, central processor unit circuitry (CPU) 622B, and graphics processor unit circuitry (GPU) 622C. The processors 602 may include any type of circuitry or processor circuitry that executes or otherwise operates computer-executable instructions, such as program code, software modules, or functional processes from memory/storage 606 to cause the UE 600 to perform operations as described herein.

In some implementations, the baseband processor circuitry 622A may access a communication protocol stack 624 in the memory/storage 606 to communicate over a 3GPP compatible network. In general, the baseband processor circuitry 622A may access the communication protocol stack to perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 604. The baseband processor circuitry 622A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 606 may include one or more non-transitory, computer-readable media that includes instructions (for example, communication protocol stack 624) that may be executed by one or more of the processors 602 to cause the UE 600 to perform various operations described herein. The memory/storage 606 include any type of volatile or non-volatile memory that may be distributed throughout the UE 600. In some implementations, some of the memory/storage 606 may be located on the processors 602 themselves (for example, L1 and L2 cache), while other memory/storage 606 is external to the processors 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 616 and proceed to filter and amplify (with a low-noise amplifier) the signal. The signal may be provided to a receiver of the transceiver that downconverts the RF signal into a baseband signal that is provided to the baseband processor of the processors 602.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 616. In various implementations, the RF interface circuitry 604 may be configured to transmit/receive signals in a manner compatible with NR access technologies.

The antenna(s) 616 may include one or more antenna elements to convert electrical signals into radio waves to travel through the air and to convert received radio waves into electrical signals. The antenna elements may be arranged into one or more antenna panels. The antenna(s) 616 may have antenna panels that are omnidirectional, directional, or a combination thereof to enable beamforming and multiple input, multiple output communications. The antenna(s) 616 may include microstrip antennas, printed antennas fabricated on the surface of one or more printed circuit boards, patch antennas, phased array antennas, etc. The antenna(s) 616 may have one or more panels designed for specific frequency bands including bands in FR1 or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensors 610 and control and allow access to sensors 610, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processors 602, the PMIC 614 may control power-source selection, voltage scaling, battery charging, or DC-to-DC conversion.

In some implementations, the PMIC 614 may control, or otherwise be part of, various power saving mechanisms of the UE 600. A battery 618 may power the UE 600, although in some examples the UE 600 may be mounted deployed in a fixed location and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

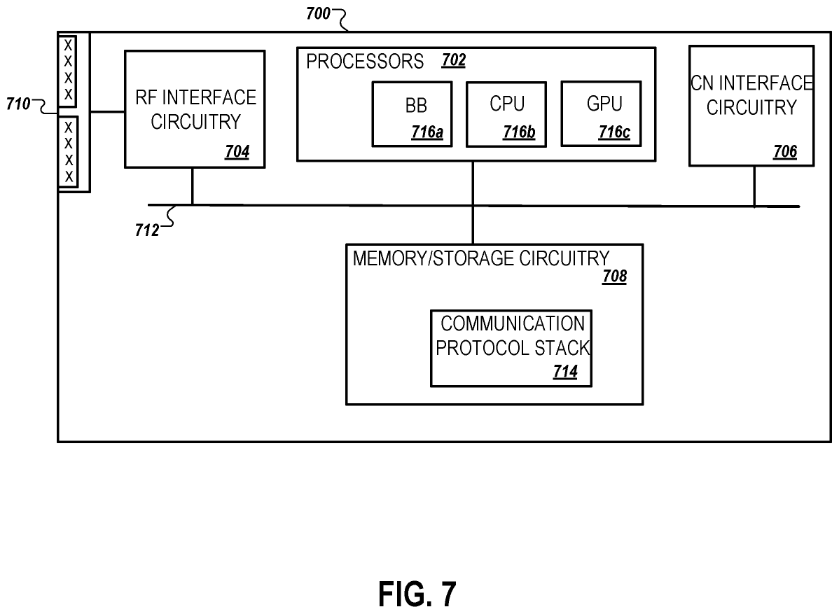

FIG. 7 illustrates an example access node 700 (e.g., a base station or gNB), according to some implementations. The access node 700 may be similar to and substantially interchangeable with base stations 110. The access node 700 may include processors 702, RF interface circuitry 704, core network (CN) interface circuitry 706, memory/storage circuitry 708, and one or more antenna(s) 710.

The components of the access node 700 may be coupled with various other components over one or more interconnects 712. The processors 702, RF interface circuitry 704, memory/storage circuitry 708 (including communication protocol stack 714), antenna(s) 710, and interconnects 712 may be similar to like-named elements shown and described with respect to FIG. 6. For example, the processors 702 may include processor circuitry such as, for example, baseband processor circuitry (BB) 716A, central processor unit circuitry (CPU) 716B, and graphics processor unit circuitry (GPU) 716C.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual baseband unit pool (vBBUP). In V2X scenarios, the access node 700 may be or act as a “Roadside Unit.” The term “Roadside Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or

### Examples

Example 1 includes a method to be performed by a first user equipment (UE), the method including: transmitting, from a first user equipment to a second user equipment, a beam failure recovery request (BFRQ) message to recover from a beam failure for a sidelink beam pair for unidirectional sidelink communication, the request identifying a new sidelink beam pair; receiving, at the first user equipment from the second user equipment, a response message confirming that the second user equipment is configured for communicating using the new sidelink beam pair that is identified in the BFRQ message; and activating, at the first user equipment based on the response message, a beam specified in the new sidelink beam pair.

Example 2 is the method of Example 1, wherein the response message comprises an acknowledgment (ACK) message.

Example 3 is the method of Example 1 or 2, wherein the request message and the response message are transmitted on a physical sidelink shared channel (PSSCH).

Example 4 is the method of any of Examples 1 to 3, wherein the response message comprises a beam failure recovery response (BFRR) message that specifies a particular new beam pair, and wherein the method further comprises: in response to receiving the BFRR message at the first user equipment, transmitting, from the first user equipment to the second user equipment, an acknowledgement message; and applying a particular new beam included in the particular new beam pair.

Example 5 is the method of any of Examples 1 to 4, wherein the particular new beam pair is the same as the identified new beam pair.

Example 6 is the method of any of Examples 1 to 5, wherein the BFRQ message is sent in a medium access control (MAC) control element (CE) that specifies a new beam identifier.

Example 7 is the method of any of Examples 1 to 6, wherein the MAC CE has a same format as a beam switching or beam indication MAC CE.

Example 8 is the method of any of Examples 1 to 7, wherein the BFRQ message is sent in a sidelink control information (SCI) stage 2 message that includes a new beam identifier.

Example 9 is the method of any of Examples 1 to 8, wherein the response message comprises a BFRR message, and wherein the BFRR message is sent in a MAC CE that specifies a new beam identifier.

Example 10 is the method of any of Examples 1 to 9, wherein the MAC CE has a same format as a beam switching or beam indication MAC CE.

Example 11 is the method of any of Examples 1 to 10, wherein the response message comprises a BFRR message, and wherein the BFRR message is sent in a sidelink control information (SCI) stage 2 message that includes a new beam identifier.

Example 12 is the method of any of Examples 1 to 11, further comprising: initiating a timer at the first user equipment; and in response to the timer expiring, declaring a sidelink radio link failure (S-RLF).

Example 13 is the method of any of Examples 1 to 12, wherein the timer initiates when the first user equipment detects sidelink beam failure.

Example 14 is the method of any of Examples 1 to 12, wherein the timer initiates when the first user equipment transmits the BFRQ message.

Example 15 is the method of any of Examples 1 to 12, wherein the timer stops when the first user equipment receives the response message from the second user equipment.

Example 16 is the method of any of Examples 1 to 12, wherein the timer stops when the first user equipment receives the response message from the second user equipment, the response comprising a BFRR message.

Example 17 is the method of any of Examples 1 to 12, wherein the timer stops when the first user equipment receives the response message from the second user equipment, the response comprising an acknowledgement (ACK) for the BFRQ message.

Example 18 is the method of any of Examples 1 to 17, wherein the BFRQ message specifies a new beam identifier, and wherein the new beam pair is activated immediately after the response message from the second user equipment is received at the first user equipment.

Example 19 is the method of any of Examples 1 to 18, wherein the BFRQ message does not specify a new beam identifier, and wherein the response message includes a BFRR message, from the second user equipment, that specifies the new beam identifier, and wherein the new beam pair is activated immediately after an acknowledgment of the BFRR message sent by the first user equipment is received at the second user equipment.

Example 20 is the method of any of Examples 1 to 19, wherein the response message includes an ACK message, and wherein the ACK message is transmitted by the second user equipment using a new beam specified in the BFRQ message.

Example 21 is the method of any of Examples 1 to 20, wherein the response message includes an ACK message, and wherein the ACK message is received by the first user equipment using a new beam specified in the BFRQ message.

Example 22 is the method of any of Examples 1 to 21, wherein the response message includes an ACK message, and wherein the ACK message based on an omnidirectional beam.

Example 23 is the method of any of Examples 1 to 22, wherein the response message includes an ACK message, and wherein the ACK message based on a configured fallback beam.

Example 24 is the method of any of Examples 1 to 23, wherein the response message includes an ACK message, and wherein the ACK message based on a serving beam.

Example 25 is the method of any of Examples 1 to 24, wherein the first user equipment is configured to measure beams of the sidelink beam pair using a sidelink synchronization signal block (S-SSB) slot.

Example 26 is the method of any of Examples 1 to 24, wherein the S-SSB slot is based on a number of (pre) configured candidate slots, wherein a location for each of the candidate slots is based on the number.

Example 27 is the method of any of Examples 1 to 24, wherein the S-SSB slot is based on a number of preconfigured candidate slots, wherein a location for each of the candidate slots is (pre) configured.

Example 28 is the method of any of Examples 1 to 25, wherein the S-SSB slot is specified in a resource pool, and wherein a sub-channel is used for transmission of the S-SSB.

Example 29 is the method of any of Examples 1 to 25, wherein the S-SSB includes a field for an identifier of the second user equipment.

Example 30 is the method of any of Examples 1 to 28, wherein the identifier of the second user equipment is shortened to fit a capacity of a physical sidelink broadcast channel (PSBCH).

Example 31 is the method of any of Examples 1 to 29, wherein a physical sidelink broadcast channel (PSBCH) scrambling sequence is generated based on an identifier of the second user equipment.

Example 32 is the method of any of Examples 1 to 29, wherein a demodulation reference signal (DMRS) scrambling sequence is generated based on an identifier of the second user equipment.

Example 33 is the method of any of Examples 1 to 32, wherein the first user equipment is configured to exchange a capability of sidelink beam correspondence in PC5-RRC signaling.

Example 34 is a method for transmitting, from a first user equipment to a base station, a beam failure recovery request (BFRQ) report to recover a beam failure for a sidelink beam pair for unidirectional sidelink communication, the report not identifying a new sidelink beam pair, wherein the base station is configured to send, to a second user equipment, a downlink control information (DCI) message that triggers a beam pairing procedure for the second user equipment; and receiving, at the first user equipment from the second user equipment, a beam pairing message.

Example 35 is the method of Example 34, wherein the report specifies an identifier that identifies the second user equipment to the base station.

Example 36 is the method of any of Examples 34 to 35, wherein the report specifies a resource pool index.

Example 37 is the method of any of Examples 34 to 36, wherein the report specifies a candidate beam.

Example 38 is a method including performing, at a user equipment, a sidelink beam measurement based on a sidelink synchronization signal block (S-SSB), the S-SSB comprising a candidate slot for the sidelink beam measurement and another slot for sidelink synchronization; and transmitting a sidelink communication based on the S-SSB sidelink beam measurement

Example 39 is the method of Examples 38, wherein the S-SSB slot is based on a number of (pre) configured candidate slots, wherein a location for each of the candidate slots is based on the number.

Example 40 is the method of any of Examples 38 to 39, wherein the S-SSB slot is based on a number of preconfigured candidate slots, wherein a location for each of the candidate slots is (pre) configured.

Example 41 is the method of any of Examples 38 to 40, wherein the S-SSB slot is specified in a resource pool, and wherein a sub-channel is used for transmission of the S-SSB.

Example 42 is the method of any of Examples 38 to 41, wherein the S-SSB includes a field for an identifier of a second user equipment.

Example 43 is the method of Example 42, wherein the identifier of a second user equipment is shortened to fit a capacity of a physical sidelink broadcast channel (PSBCH).

Example 44 is the method of Example 42, wherein a physical sidelink broadcast channel (PSBCH) scrambling sequence is generated based on an identifier of a second user equipment.

Example 45 is the method of Example 42, wherein a demodulation reference signal (DMRS) scrambling sequence is generated based on an identifier of a second user equipment.

Example 46 may include an apparatus including logic, modules, and/or circuitry (e.g., processing circuitry) to perform one or more elements of a method described in or related to any of examples 1-45, or any other method or process described herein.

Example 47 may include a method, technique, or process as described in or related to any of examples 1-45, or portions or parts thereof.

Example 48 may include an apparatus including: one or more processors and one or more computer-readable media including instructions that, when executed by the one or more processors, cause the one or more processors to perform the method, techniques, or process as described in or related to any of examples 1-45, or portions thereof.

Example 49 may include a signal as described in or related to any of examples 1-45, or portions or parts thereof.

Example 50 may include a computer program including instructions, wherein execution of the program by a processing element is to cause the processing element to carry out the method, techniques, or process as described in or related to any of examples 1-45, or portions thereof. The operations or actions performed by the instructions executed by the processing element can include the methods of any one of examples 1-45.

Example 51 may include a method of communicating in a wireless network as shown and described herein.

Example 52 may include a system for providing wireless communication as shown and described herein. The operations or actions performed by the system can include the methods of any one of examples 1-45.

Example 53 may include a device for providing wireless communication as shown and described herein. The operations or actions performed by the device can include the methods of any one of examples 1-45.

The previously-described examples 1-45 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-20. (canceled)

21. One or more processors configured to cause a first user equipment (UE) to perform operations comprising:
transmitting, to a second user equipment, a beam failure recovery request (BFRQ) message to recover from a beam failure for a sidelink beam pair for unidirectional sidelink communication, the request identifying a new sidelink beam pair;
receiving, from the second user equipment, a response message confirming that the second user equipment is configured for communicating using the new sidelink beam pair that is identified in the BFRQ message; and
activating, based on the response message, a beam specified in the new sidelink beam pair.

22. The one or more processors of claim 21, wherein the response message comprises an acknowledgment (ACK) message.

23. The one or more processors of claim 21, wherein the request message and the response message are transmitted on a physical sidelink shared channel (PSSCH).

24. The one or more processors of claim 21, wherein the response message comprises a beam failure recovery response (BFRR) message that specifies a particular new beam pair, and wherein the operations further comprise:
in response to receiving the BFRR message, transmitting, to the second user equipment, an acknowledgement message; and
applying a particular new beam included in the particular new beam pair.

25. The one or more processors of claim 21, wherein the BFRQ message is sent in a medium access control (MAC) control element (CE) that specifies a new beam identifier.

26. The one or more processors of claim 21, wherein the BFRQ message is sent in a sidelink control information (SCI) stage 2 message that includes a new beam identifier.

27. The one or more processors of claim 21, wherein the response message comprises a BFRR message, and wherein the BFRR message is sent in a MAC CE that specifies a new beam identifier.

28. The one or more processors of claim 21, the operations further comprising:
initiating a timer; and
in response to the timer expiring, declaring a sidelink radio link failure (S-RLF);
wherein the timer initiates when the sidelink beam failure is detected or when the BFRQ message is transmitted, and
wherein the timer stops when the response message comprising a BFRR message is received from the second user equipment or when the response message comprising an acknowledgement (ACK) for the BFRQ message is received from the second user equipment.

29. The one or more processors of claim 21, wherein the BFRQ message specifies a new beam identifier, and wherein the new beam pair is activated immediately after the response message from the second user equipment is received.

30. The one or more processors of claim 21, wherein the BFRQ message does not specify a new beam identifier, and wherein the response message includes a BFRR message, from the second user equipment, that specifies the new beam identifier, and wherein the new beam pair is activated immediately after an acknowledgment of the BFRR message is received at the second user equipment.

31. The one or more processors of claim 21, wherein the response message includes an ACK message, and wherein the ACK message is received using a new beam specified in the BFRQ message, wherein the ACK message based on an omnidirectional beam, wherein the ACK message based on a configured fallback beam, or wherein the ACK message based on a serving beam.

32. The one or more processors of claim 21, wherein the first user equipment is configured to measure beams of the sidelink beam pair using a sidelink synchronization signal block (S-SSB) slot,
wherein the S-SSB slot is based on a number of (pre) configured candidate slots, wherein a location for each of the candidate slots is based on the number, wherein the S-SSB slot is based on a number of preconfigured candidate slots and a location for each of the candidate slots is (pre) configured, or wherein the S-SSB slot is specified in a resource pool, and a sub-channel is used for transmission of the S-SSB.

33. The one or more processors of claim 32, wherein the S-SSB includes a field for an identifier of the second user equipment.

34. The one or more processors of claim 33, wherein the identifier of the second user equipment is shortened to fit a capacity of a physical sidelink broadcast channel (PSBCH).

35. The one or more processors of claim 33, wherein a physical sidelink broadcast channel (PSBCH) scrambling sequence is generated based on an identifier of the second user equipment.

36. The one or more processors of claim 33, wherein a demodulation reference signal (DMRS) scrambling sequence is generated based on an identifier of the second user equipment.

37. An apparatus comprising:
a transceiver;
one or more processors;
a memory storing instructions that, when executed by the one or more processors, cause the one or more processors to perform operations comprising:
encoding, for transmission by the transceiver to a base station, a beam failure recovery request (BFRQ) report to recover a beam failure for a sidelink beam pair for unidirectional sidelink communication, the report not identifying a new sidelink beam pair, wherein the base station is configured to send, to a second user equipment, a downlink control information (DCI) message that triggers a beam pairing procedure for the second user equipment; and
decoding a beam pairing message received by the transceiver from the second user equipment.

38. The apparatus of claim 37, wherein the report specifies an identifier that identifies the second user equipment to the base station, a resource pool index, a candidate beam, or a combination thereof.

39. A method for wireless communication, the method comprising:
performing a sidelink beam measurement based on a sidelink synchronization signal block (S-SSB), the S-SSB comprising a candidate slot for the sidelink beam measurement and another slot for sidelink synchronization; and
transmitting a sidelink communication based on the S-SSB sidelink beam measurement

40. The method of claim 39, wherein the S-SSB includes a field for an identifier of a second user equipment, and wherein the candidate slot is based on a number of (pre) configured candidate slots, wherein a location for each of the candidate slots is based on the number and the candidate slot is based on a number of preconfigured candidate slots, wherein a location for each of the candidate slots is (pre) configured, or wherein the candidate slot is specified in a resource pool, and wherein a sub-channel is used for transmission of the S-SSB.
